(19) United States
(12) Patent Application Publication
(10) Pub. No.: US 2008/0233550 A1
(43) Pub. Date: Sep. 25, 2008

(54) Method and apparatus for technology-enhanced science education

(75) Inventor: Peter R. Solomon, West Hartford, CT (US)

Correspondence Address: IRA S. DORMAN, 330 ROBERTS STREET, SUITE 200, EAST HARTFORD, CT, 06108, US

(73) Assignee: Advanced Fuel Research, Inc.

(21) Appl. No.: 12/006,983

(22) Filed: Jan. 8, 2008

Related U.S. Application Data
(60) Provisional application No. 60/897,018, filed on Jan. 23, 2007.
(60) Provisional application No. 60/933,198, filed on Jun. 5, 2007.

(51) Int. Cl. G09B 23/00; G09B 7/00; G09B 25/00

(52) U.S. Cl. 434/276; 434/322; 434/428

(57) ABSTRACT

The interactive science learning method consists of a sequence of hands-on experiments with matching computer simulations that connect a student's prior experience to core science concepts, and the apparatus implements the learning method. A tutorial is employed to evoke a student's prior experience, and equates that experience with a hands-on laboratory experiment performed by the student. Computer generated simulations emulate the hands-on experiment to reinforce the concept, by picturing the phenomenon more completely and by allowing the student to instantaneously see how changing input variables affects an outcome, and may also extrapolate the concept to different physical scales. A remote sensor device, such as may for example incorporate an accelerometer feature, can be employed to transmit, in real time, signals containing information that is representative of phenomena that are sensed or experienced by the student, for use in the computer-generated simulations.

### CROSS REFERENCE TO RELATED APPLICATIONS

This application claims the benefit of U.S. Provisional Patent Applications No. 60/897,018, filed Jan. 23, 2007, and No. 60/933,198, filed Jun. 5, 2007, the entire specifications of which are incorporated hereinto by reference.

### STATEMENT OF GOVERNMENT INTEREST

This invention was made with Government support under Contract No. ED-06-PO-0907, awarded by the U.S. Department of Education. The Government has certain rights in the invention.

### BACKGROUND OF THE INVENTION

The present invention addresses six problems in science education: I. the declining numbers of individuals, particularly U.S. citizens, who are trained to become scientists and engineers; II. the insufficient numbers of certified science teachers in mid-level schools (e.g., U.S. middle schools), where keeping young minds interested in science is critical; III. the conclusion of the U.S. National Research Council, that “the current organization of science curriculum and instruction does not provide the kind of support for science learning that results in deep understanding of scientific ideas and an ability to engage meaningfully in the practice of science;” IV. the National Assessment of Educational Progress (NAEP) report that 8^{th} grade science proficiency is not improving; V. the conclusion of the New Commission on the Skills of the American Workforce that “the world has changed, but the American classroom, for the most part has not”; and VI. the low deployment of technology to improve science learning, even while there is a vast array of software-based science material available, while there is extensive government sponsored development of Technology Enhanced Learning Environments (TELEs), and while computers are becoming more available in schools.

### BRIEF SUMMARY OF THE INVENTION

It is a broad object of the present invention to provide a novel system and method by which modern computer capabilities can be harnessed effectively for teaching science.

It is a more specific object of the invention to provide such a system and method into which pertinent hands-on experiments and/or data representative of ambient phenomena can be integrated to afford significant pedagogical benefits.

It has now been found that certain of the foregoing and related objects of the invention are attained by the provision of a system for teaching scientific concepts, comprised of a plurality of components and including programmed electronic data processing means, comprised of at least one local computer, and at least one tangible experimentation device. The electronic data processing means is programmed for dynamically simulating and displaying on the local computer an experiment that utilizes at least one variable parameter and that involves a scientific concept to which the variable parameter is pertinent. The tangible experimentation device is adapted for use in performing a hands-on experiment that utilizes the same variable parameter and is illustrative of the same scientific concept.

Objects of the invention are also attained by the provision of such a system which includes, in addition to the programmed electronic data processing means, a detector device comprising at least one detector that is responsive to an ambient phenomenon involving the variable parameter that is utilized in the computer-simulated experiment. The detector device is constructed for generating a signal that is representative of the detected phenomenon, and is operatively connected to the local computer for inputting the representative signal thereinto, for processing by the electronic data processing means, the local computer being constructed for receipt and processing of the representative signal for varying the variable parameter of the simulated experiment.

In preferred embodiments, the system will comprise, in addition to the electronic data processing means, both the tangible experimentation device and also the detector device. The ambient phenomena to which the detectors of such a device are responsive may be motion, velocity, acceleration, sound, light, force, pressure, weight, volume, distance, thermal conditions, magnetic fields, electric fields, odor, taste, and chemical properties, and in certain embodiments the detector device will desirably be hand-held.

In most instances, the electronic data processing means will be programmed for receipt and processing of signals generated by direct inputs to the local computer, for varying the at least one variable parameter of the simulated experiment, with the local computer being constructed for receiving such direct inputs. The electronic data processing means will usually also be programmed and constructed for interactive receipt of such direct inputs, and it will usually include an Internet server to which the local computer can be operatively connected, the Internet server normally being programmed for carrying out the simulated experiments.

In preferred embodiments of the invention, the electronic data processing means will be programmed for simulating and displaying a plurality of experiments involving different scientific concepts. Such a system will usually also include a plurality of tangible experimentation devices, at least one of which will utilize a variable parameter that is illustrative of each of the scientific concepts. The functional features of a tangible experimentation device will desirably match the features of the corresponding simulated experiment in all significant respects, and the simulated experiment may illustrate the scientific concept involved on a human-size scale, on an atomic-size scale, and/or on a cosmic-size scale; preferably, it will illustrate the concept on a human-size scale and at least one of the other two scales, and most desirably on all three scales.

Generally and advantageously, the electronic data processing means will additionally be programmed for presenting, on the local computer and by visual or audial means, or both, a supplemental educational tool related to the scientific concept. Such a supplemental tool may include a tutorial, student activities-evoking materials, experiment-extrapolating materials, a concept organizer, teacher instructions, science-based vocabulary, lyrics, music, and combinations thereof (e.g., an animated, “rap” music presentation), and will desirably have means thereon for correlating its subject matter to the corresponding scientific concept. The system will usually additionally include tangible printed materials, which will desirably also have such correlating means thereon. The correlating means will normally take the form of symbols, icons, and the like.

Other objects of the invention are attained by the provision of a method for teaching scientific concepts, utilizing the system herein described. When the system includes all three of the basic components identified (i.e., the programmed electronic data processing means, the tangible experimentation device, and the detector device), the method will broadly comprise the steps: operating the electronic data processing means so as to dynamically simulate and display on the local computer an experiment that utilizes at least one variable parameter and that involves a scientific concept to which the variable parameter is pertinent; performing, by use of the tangible experimentation device, a hands-on experiment that utilizes the same variable parameter and is illustrative of the same scientific concept; and subjecting the detector device to an ambient phenomenon that involves the same variable parameter so as to input into the local computer a representative signal generated by the detector. As will be evident, the steps utilized to carry out the method of the invention will correspond to the functional features of the apparatus employed.

### BRIEF DESCRIPTION OF THE SEVERAL VIEWS OF THE DRAWINGS

FIG. 1 comprises six panels including, at the top, human-size scale tutorial illustrations and, at the bottom, corresponding atomic-size scale computer simulations, all relating to energy conversion in a car crash.

FIG. 2 is a pictorial illustration of the “Four-E” model used to connect student experience to core concepts at size scales ranging from atomic to cosmic.

FIG. 3 depicts a student shooting a basketball, while wearing on his wrist a remote sensor, which is in wireless communication with a computer that simulates and displays the action of shooting baskets.

FIG. 4 reproduces the screen image on the terminal of the computer of FIG. 3, showing the scientific terms applicable to describe the basketball shot, which is animated, in actual practice.

FIG. 5 reproduces the display on a computer terminal screen, produced by a computer simulation of a hands-on experiment that can be performed utilizing the device depicted, wherein scientific terms are applied to describe a projectile launch.

FIG. 6 depicts a computer terminal screen display presenting, under student control of parameters (by means not shown), a user interface for simulation of orbits of the moon around the earth.

FIG. 7 depicts a computer terminal screen display presenting, under student control of a velocity parameter, a graphical user interface (GUI) for simulation of orbits of an electron around an atomic nucleus.

FIG. 8 comprises six computer display panels constituting a simulation of atoms during phase changes from solid, to liquid, to gaseous states.

FIG. 9 depicts a computer terminal screen display presenting a simulation of a simple heat engine, in which a jet of gas drives a turbine wheel and in which student control of the turbine wheel mass parameter is enabled through the GUI.

FIG. 10 depicts a computer terminal screen display presenting a simulation of the transformation of mechanical energy to electricity and enabling student control, through the GUI, of movement of a wire in a magnetic field.

FIG. 11 depicts a computer terminal screen display of an index of representative simulations that can be employed in implementing the method and apparatus of the invention and can function, for example, as a menu for selection.

FIG. 12 depicts a hands-on experiment, and a corresponding atomic-size scale computer simulation of a scientific concept involving phase change, in which the temperature measured by a sensor used in the hands-on experiment is employed as a real-time input to the simulation of atoms in the phase being studied, and in which computer-based information is loaded from a remote server, to the local computer, over the Internet.

FIG. 13 depicts the GUI of the local computer for the simulation described in FIG. 12.

FIG. 14 is a diagrammatic illustration of a hand-held sensor, or detector, device constructed for use in connection with certain embodiments of the invention.

FIG. 15 is a computer display of material delivered from a web portal for a “What do You Know” activity of a “Gravity and Other Forces” “Science Unit,” showing icons for linkage to information relative to the scientific concepts available.

FIG. 16 is a computer display of a “Concept Organizer” designed to help students learn the terms and concepts of the “Gravity and Other Forces” “Science Unit” referred to in FIG. 15, and bearing some of the same icons.

FIG. 17 depicts a tangible worksheet for use by a student in connection with a “Galileo's Experiment” simulation activity from the “Gravity and Other Forces” “Science Unit” described in FIGS. 15 and 16.

### DETAILED DESCRIPTION OF THE INVENTION

The present invention harnesses modern computer capabilities for teaching science, and provides a unique combination of hands-on experiments with matching simulations organized in a “Four-E” teaching method, integrated within a “Five-E” learning cycle, as discussed below. The method and apparatus of the invention essentially and uniquely connect student experiences to core science concepts.

More particularly, the invention addresses the science education problems discussed above, by the provision of a method and apparatus that are based upon “Science Units” and are visual, dynamic, and interactive. The invention focuses on major core science concepts, presented consistently from grade to grade, and serves to engage students in directed science inquiry.

As shown in Table I below, the “Science Units” integrate tutorials, computer simulations, hands-on experiments, and peer interactions to engage the students' visual, auditory and kinesthetic senses, as well as their learning preferences (tutorials, illustrations, inquiry, experiment, peer interaction and collaboration). The components are integrated in a Technology Enhanced Learning Environment (TELE), which allows all the components to be delivered using a single software environment.

TABLE 1
Components of the Science Units

| | | Learning | |
|---|---|---|---|
| Component | Technology | Perspective | Setting |
| Tutorial | Presentation with | Visual, Auditory, | Classroom |
| | pictures, anima- | Peer Interactions, | Computer & |
| | tion, sound and | Illustrations | Projector |
| | video clips | | |
| Computer Sim- | Molecular Dyna- | Visual, Auditory, | Computer Lab |
| ulations of | mics/Object | Inquiry, Experi- | |
| Physical Experi- | Motion Simulator | ment, Peer Colla- | |
| ments | software | boration | |
| Hands on Physi- | Apparatus and | Visual, | Laboratory/ |
| cal Experiments | probes | Kinesthetic, In- | Classroom |
| | | quiry, Experi- | |
| | | ment, Peer Colla- | |
| | | boration | |
| Student Mini | Posters, props and | Visual, Auditory, | Classroom |
| Presentation | blackboard comp- | Peer Colla- | |
| | uters, music, | boration | |
| | rhyme | | |

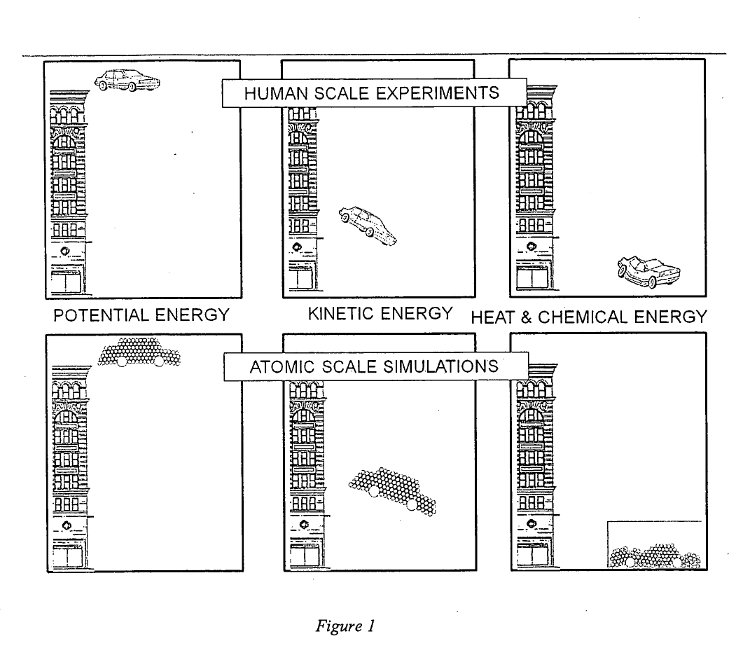

As an example of the way in which “human size scale” phenomena and “atomic size scale” simulations can be connected, FIG. 1 of the drawings shows how a computer simulation of energy conversion, from potential, to kinetic, to heat and chemical energy on an “atomic scale,” helps to illustrate the mechanisms underlying a car crash. The top panels show an imaginary experiment in which a car is purposely dropped from a building, is falling rapidly before impact (middle panel), and is demolished (deformed) after impact (right panel). These stages are duplicated in the “atomic scale” simulation depicted in the lower three panels. Students identify the energy forms and amounts at each state of the experiment using the core concept of conservation of energy.

In a typical “Science Unit,” the four components in Table I are to be organized into the “Five-E” inquiry-based model (see Bybee, R. W. Learning Science and the Science of Learning, NSTA Press, VA, 2002, and Bybee, R. W., Achieving Scientific Literacy: From Purposes to Practices, Heinermann, Portsmouth N.H., 1997). The pre-test that determines a student's prior knowledge of concepts as well as his misconceptions is the “Evaluate” step.

A problem or mystery which poses a situation for which students, working in teams, must find a solution is the “Engagement” step; e.g., how fast must a daredevil motorcyclist go, and what angle should he use for a ramp, to successfully jump the Grand Canyon? A tutorial and simulation using a classroom computer and projector is used for this step.

In the Explore” step, students use the tutorials (delivered in the classroom or narrated on a school or home computer), hands-on experiments, and computer simulations to acquire the information needed to solve the problem. The tutorials emphasize the important physical concepts underlying the problem and specifically address misconceptions determined in the Evaluate step.

In the Extend” and “Explain” steps, students analyze the data to determine a solution to the problem, organize a presentation to their class in which they present their solution, and then test their solution in a simulation in front of the class. The post-assessment in step 5 “Evaluate” measures how well students have mastered the concepts.

By creating dynamic, animated, engaging and interactive lessons for the middle school science curriculum, the present invention will stimulate more interest in pursuing science and engineering at an important “tipping-point” in the student's education. By creating a state-of-the-art TELE, with the manuals, tutorials, experiments, information exchange and Teacher Professional Development materials provided, the project will allow even out-of-field teachers to deliver quality, interesting and stimulating science lessons, and will stimulate teacher learning. By creating inquiry-based lessons focusing on the core science concepts using hands-on experiments, simulation and tutorials, students will learn the concepts and the methods of doing science. By improving the curriculum, test scores should increase. By having students cooperate in groups to solve problems using inquiry-based methods and modern information technology, they will learn the applied skill required by the modern economy. And by addressing the barriers to entry, more rapid introduction of TELEs will be achieved.

Creation of the “Science Units” has been guided by extensive work on what students should learn in science, how they learn, and what skills they should acquire. General goals have previously been set for the scope of science education in the middle school; the common themes presented by the organizations that set the goals are:
Students should learn in depth the most important core science concepts.
Students should attain the ability to apply the process of scientific inquiry.
Students should be able to connect scientific concepts with their prior knowledge.
Students should understand how science relates to the technological, economic, environmental and health issues that affect their lives.
   The “Science Units” employed in the present method and apparatus have been developed to meet the foregoing general goals.

The “Science Units” integrate multiple components (tutorials, hands-on experiments and computer simulations) to engage the student's visual, auditory, kinesthetic senses and learning preferences. This approach is in line with Gardner's concepts of “Multiple Intelligences” (see Gardner, Howard, Multiple Intelligences, Basic Books 1193, and Gardner, Howard, The Unschooled Mind, Basic Books 1991), which suggests that, since students learn in different ways, they should have access to materials that present concepts from different perspectives. The present multi-component approach matches most of the patterns of learning (Concept orientation; Predict, Observe, Explain; Illustrations; Experiments; Explore and Simulate; Critique; Collaborate; and Reflect) outlined in a recent summary of knowledge integration in science education (see Linn, M. C and Eylon, Bat-Sheva Handbook of Educational Psychology, 2^{nd} Addition, May 6 Alexander, P. A. and Winne, P. H. Eds).

The “Science Units” are organized around an inquiry process. Research on the inquiry method is summarized in a number of publications (see for example, Inquiry and the National Science Education Standards, National Research Council, National Academy Press, Washington, D.C. 2000; and Haury, D. I. ERIC CSMEE Digest March (Ed 359 048) 1993; and Flick, L. B. Complex Classrooms: A synthesis of Research on Inquiry Teaching Methods and Explicit Teaching Strategies, Presented at the annual meeting of the National Association of Research in Science Teaching, San Francisco (Ed 383 563) 1995). The first reference concludes that the results for inquiry depend on the learning goals. Inquiry is effective when the learning goals include (as the standards require) the understanding and ability to apply inquiry to answer scientific questions. While undirected “open inquiry” is not appropriate for the middle school, directed inquiry, as in the present “Learning Cycle,” would improve learning of concepts while acquiring inquiry skills. The components of the “Science Units” are part of the inquiry-based “Five E” learning cycle.

The “Science Units” use of simulation is supported by research that has shown that games and interactive simulations are more dominant compared with traditional teaching methods for cognitive gain outcomes. In addition, simulation is a valuable and common form of science and engineering investigation, and exposure to this method should be a part of any modern learning experience.

One obvious problem that exists in achieving a high level of competence in both traditional “basic skills” and also many new “applied skills” is that classrooms are primitive when compared to the workplace, where modern computer technology increases productivity and provides instantaneous availability of information, and also when compared to the resources that many students have available to them in their own homes for computing, Internet access and games. Market research shows that 88% of teachers still use text books as their core teaching tool, even though, according to the survey results, this is the student's least favorite learning tool. There is therefore an obvious mismatch in teaching present-day students, using outmoded technology.

In the “Science Units” of the present methodology, student teams may perform research in a computer-based environment to solve problems that elucidate important core science concepts, and may then report on their results. These activities will support both the basic skills (science content, and the ability to perform inquiry) as well as the following modern applied skills:

| | |
|---|---|
| Knowing more about the world | Teamwork and |
| | collaboration |
| Thinking outside the box | Communication |
| | skills |
| Developing good people skills | Creativity/Inno- |
| | vation |
| Critical Thinking/ | Information Tech- |
| | nology |
| Becoming smarter about new sources of information | Problem solving |

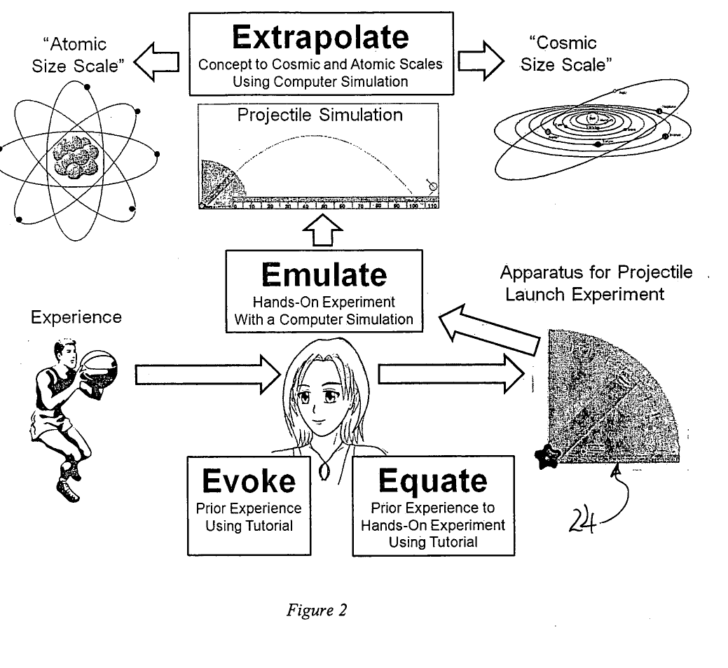

As an example, illustrated in FIG. 2 of the drawings, the core concept of the force of gravity, and how it affects trajectories of objects, is demonstrated using the “Four-E” model. A tutorial is employed to Evoke a student's prior experience (e.g., with basketball) that illustrates the core science. The prior experience is Equated with a hands-on laboratory experiment in which students observe trajectories of objects as a function of launch angle and speed, using an experimentation device 24. Then, a computer simulation is employed to Emulate the hands-on experiment, to reinforce the concept by picturing the trajectories and allowing students to see how changing the force of gravity affects the trajectory. This helps the student connect the principles (which are often more easily illustrated in the simulation) with his “human-size scale” experience. Simulations also have the advantage of allowing students more range in the parameters that can be explored, and of providing instantaneous feedback as to the outcome of changes in the input. Simulations can then be used to Extrapolate the force/trajectories concept to “cosmic-size scale” objects, where the force is gravity (e.g. the moon circling the earth), or to “atomic-size scale” objects, where the force is electromagnetic (e.g. electrons circling the nucleus). This approach allows the understanding of one system being applied to another, and consistently reinforces the basic concepts of how forces control motion. While individual components, hands-on experiments, and simulations of the kind used in the instant teaching method may be available from other sources, the present invention uniquely combines and applies the Four-E (Evoke, Equate, Emulate and Extrapolate) method with matching hands-on and simulation experiments.

As specific example of the Four-E teaching method, as applied the present invention, the core concept of the force of gravity, and how it affects trajectories of objects, is also illustrated in FIG. 2 of the drawings. Thus, as step 1 of the method a multi-media tutorial, using pictures, animations, video and sound, is employed to Evoke a student's prior experience that illustrates the core concept, i.e., making a basketball shot. The tutorial is best delivered using a computer and projector in front of a class, using software such as Microsoft Power Point, Flash, or other such package which can provide for pictures, animations, video clips and sound.

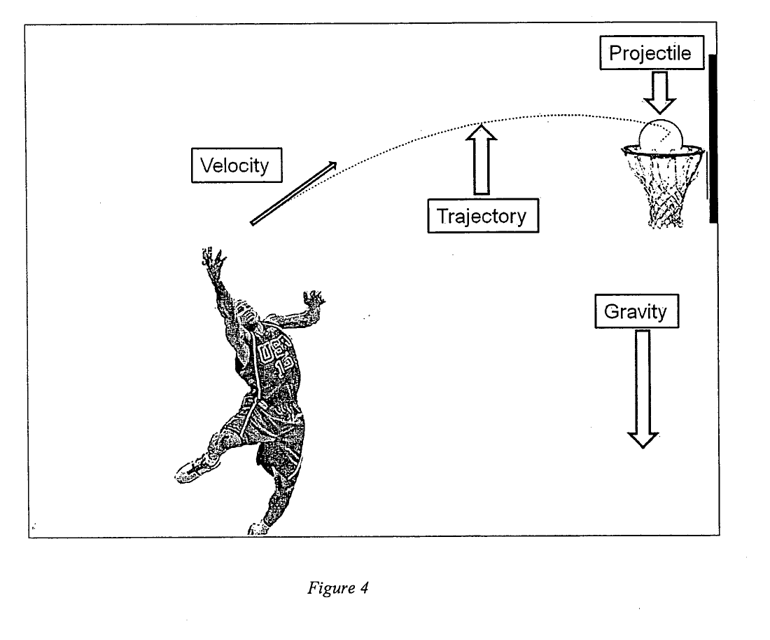

FIG. 4 illustrates the manner in which a computer-generated basketball animation is used as a medium for defining, through illustration, the scientific terms applicable to describe how a shot is made. Other experiences that involve the same principles are also Evoked, providing as the basis for a class discussion of all of the phenomena that students have experienced and that involve the same physical principles.

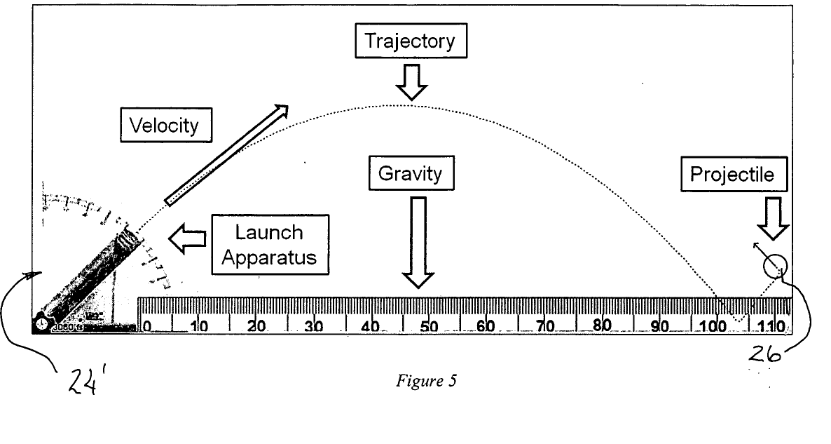

As step 2 of the method, and still with reference to FIG. 2, use of the tutorial is continued to Equate a hands-on experiment (which students will thereafter perform in a timely fashion, e.g., during the next several days) to the prior experiences, which they have Evoked. The hands-on experiment is performed as step 3 of the method, using a tangible experimentation device, such as the adjustable launch apparatus generally designated by the numeral 24 in FIG. 2 (and the virtual replication thereof 24′, depicted in FIG. 5), with a cork projectile 26 (shown in the simulation of FIG. 5). In the hands-on experiment, the students make measurements of the actual distance traveled by the projectile, as a function of the launch velocity and launch angle, and they record and plot the data. Post-lab discussions summarize the trends that were observed, and encourage students to think about the factors that control the motion.

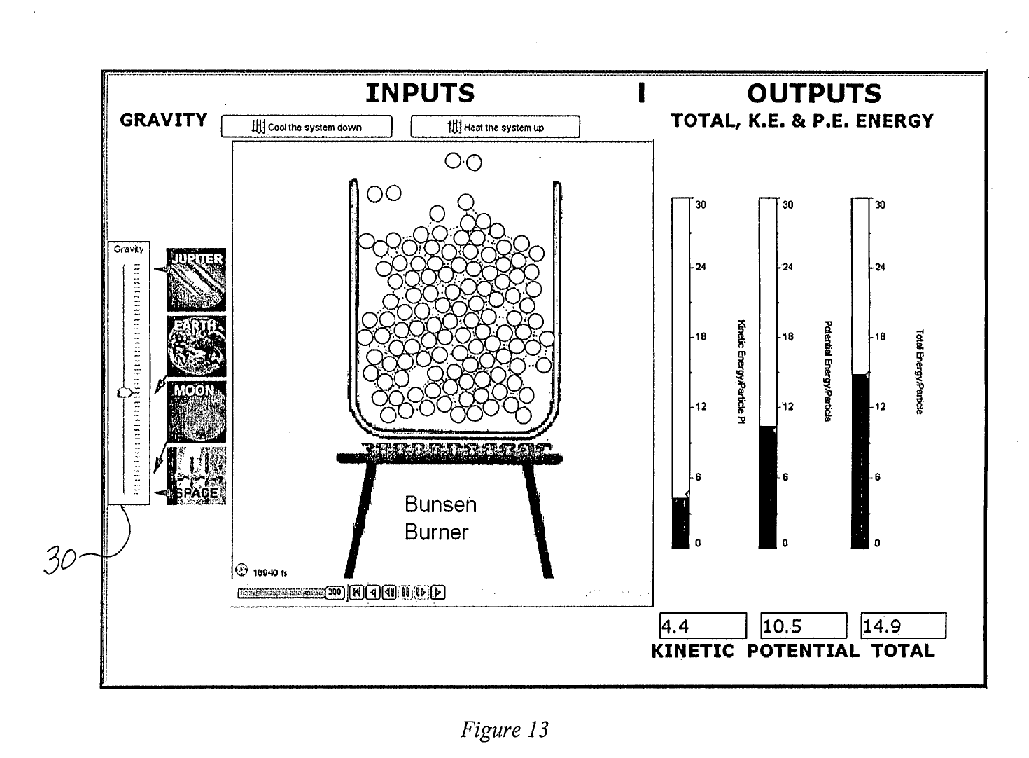

As step 4 of the method, an interactive computer simulation is used to Emulate the hands-on laboratory experiment that the students had previously performed. The graphical user interface for the simulation includes the simulation model 24′ interface illustrated in FIG. 5. As can be seen, the simulation allows students to duplicate their hands-on experiments in which they measure distance traveled as a function of launch angle and launch speed, which may be selectively controlled with slide bars on the computer screen (not shown in this figure, but depicted, for example, as element 30 in FIG. 13 in connection with a different concept); as can be seen, however, the simulation leaves a trace of the path of the projectile (i.e., its trajectory). In addition to the other variables, the simulation may allow the varying of gravity using another slide bar; those data would then be included in discussions of the factors that control trajectories and other motions.

The simulation described not only allows the students to duplicate the experience of the hands-on experiment, to reinforce what they have already learned, but it also affords the added advantages of seeing the trajectory, exploring the effects of gravity, and receiving instantaneous feedback from changes made in input variables. Software programs such as Concord Consortium's “Molecular Workbench,” or other equivalent software that simulates the motion of objects under the influence of forces, may be used for this step.

As step 5 of the method, a classroom tutorial and simulation presentation is employed to explain the core concepts underlying what the students have observed. In the embodiment presently described, the presentation starts with a discussion of the force of gravity. The tutorial explains how the force of gravity controls the weight and motion of objects on earth, relating the discussion to what students have learned in the previous steps.

Steps 1 through 5 are normally performed, in accordance with the present invention, to connect a core concept (e.g., the effects of gravity upon the motion of objects) with the student's prior experience, allowing the exploration, analysis, and understanding of the controlling factors. The multi-media lesson taps into the student's visual, audio and kinesthetic senses, and allows access to the student's preferred learning experience.

In a further aspect of the method of the invention, a tutorial and the simulation software are employed, as a sixth step, to Extrapolate the core concept from the student's experience, with “human-size scale” objects, to “cosmic-size scale” objects (such as the planets orbiting the sun, where the force is gravity) and “atomic-size scale objects” (such as electrons orbiting the nucleus, where the force is electromagnetic), as discussed above (these extrapolations are also illustrated in FIG. 2).

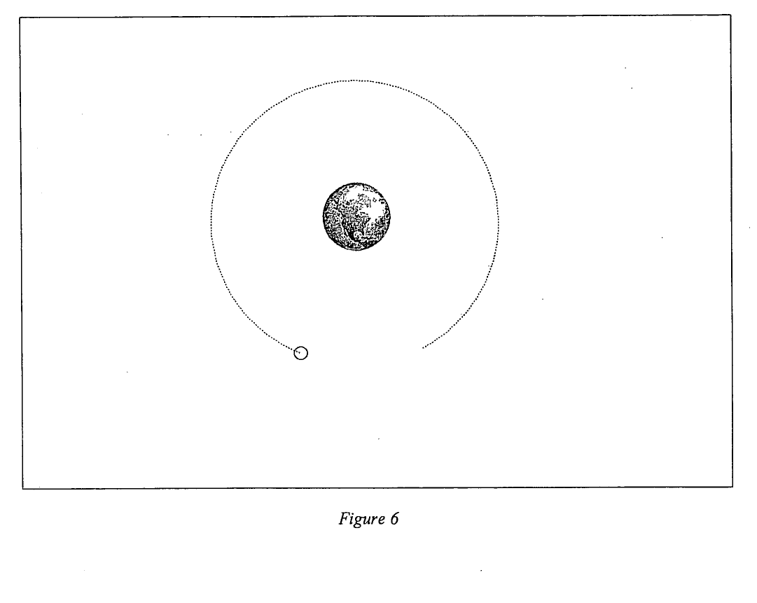

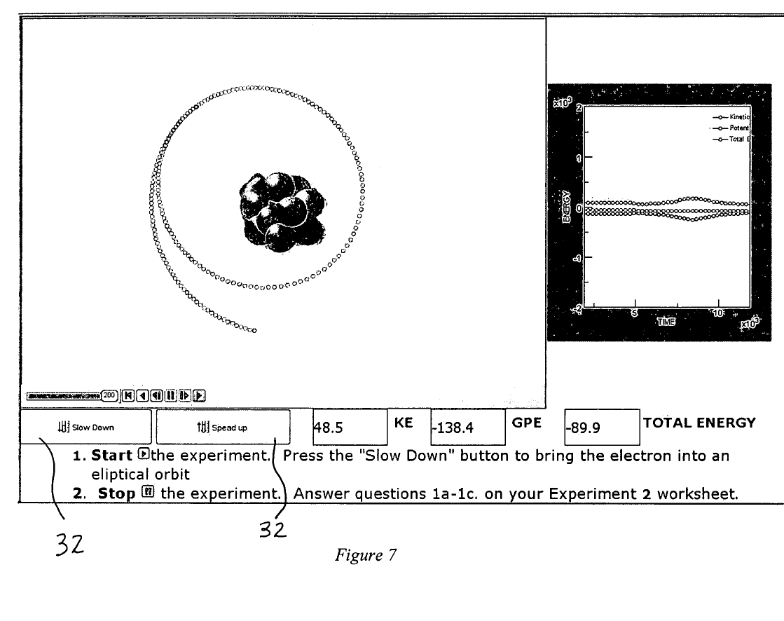

More specifically, FIG. 6 illustrates a simulation at “cosmic-size scale” of the moon orbiting the earth, in which students explore how changes in the moon's velocity, made by varying pertinent parameters (not shown here), will affect the moon's trajectory. Similarly, FIG. 7 illustrates a simulation at “atomic-size scale” of the electrons orbiting a proton, in which students explore how changes in the electron's velocity will affect its trajectory, again by variation of the computer parameters (which are the same as those that are pertinent to the simulation of FIG. 6). The observations made may then be discussed in terms of their relationship to the previously obtained understanding of distance verses launch angle of relationships applicable to projectiles.

The foregoing presentation of the concept of forces and motion, utilizing the “Four-E” methodology, connects the concept to the student's prior experience, illustrates the concept from multiple perspectives (tutorial, hands-on experiments, computer simulations), and applies the same concept at different (“human”, “atomic”, and “cosmic”) size scales. The successful result is an improved understanding of core concepts and their importance throughout the physical world.

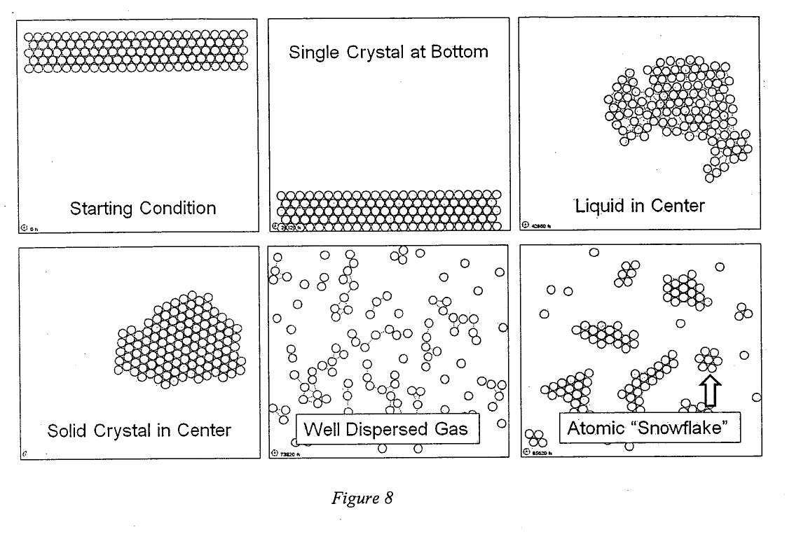

There are of course many other examples of simulations that can be matched to hands-on experiments. FIG. 8 illustrates the concept of phase changes of matter, which can readily be matched to observations of commonplace changes of state that occur in water. The changes that occur in the computer simulation can be effected by student-controlled energy variations.

Another simulation example involves an experiment (not illustrated) at “cosmic-size scale,” in which students simulate the greenhouse effect by choosing the energy levels for the earth and the greenhouse gases. The corresponding “human-size scale,” hands-on experiment would entail measurement of the heat (temperature) inside a miniature greenhouse constructed of glass, which can be matched almost exactly with a “human-size scale” simulation of a greenhouse. Other experiments, in which light is attenuated by colored filters, can be matched by “human-size scale” simulation which can be extrapolated to an “atomic-size scale.”

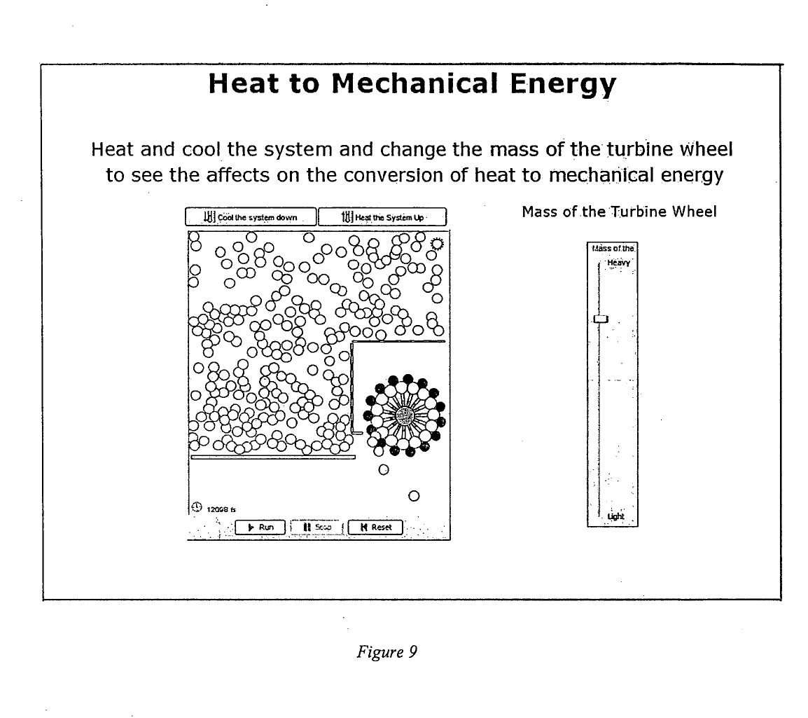

FIG. 9 illustrates, on an “atomic-size scale,” how heated atoms drive a turbine wheel. A companion physical demonstration might involve driving a pinwheel with a jet of steam.

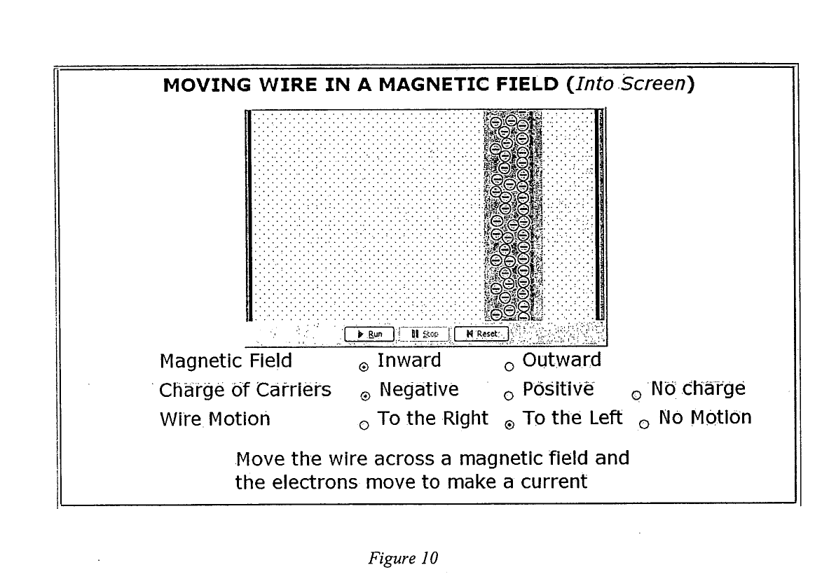

FIG. 10 illustrates, also on an “atomic-size scale,” electrons in a wire which move when the wire is moved in a magnetic field. Using a computer simulation, students can explore how the electrons flow when changes are made to the direction of the magnetic field, the direction of wire motion, and the charge of carriers; corresponding hands-on experiments can be conducted.

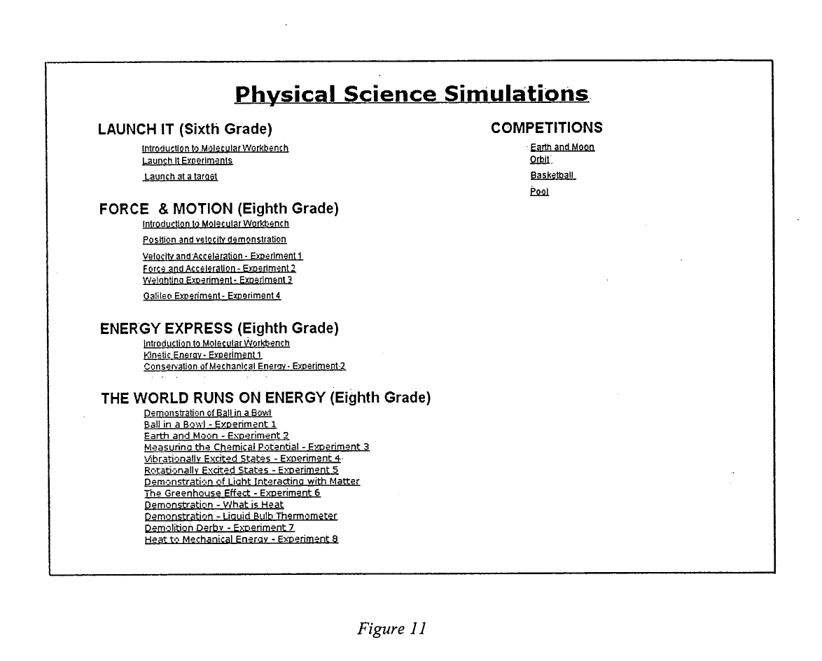

An index of exemplary simulations that are suitable in the practice of the present invention is presented in FIG. 11. Other matched experiments and simulations which can be employed involve, for example, conservation of kinetic and potential energy, energy levels of bound objects, diffusion, gas laws, hydraulics, etc. Additional concepts, principles, and simulations to which the method and apparatus of the invention can be applied will be evident to those skilled in the art.

Thus, the unique combination of hands-on experiments with matching computer simulations, organized in a “Four-E” teaching method in accordance with the present invention, provides an engaging and interactive learning sequence that connects a student's prior experience to core science concepts. A tutorial is employed to Evoke a student's prior experience and “Equates” that experience with a hands-on laboratory experiment which students will perform. A computer simulation is then employed to “Emulate” the hands-on experiment, to reinforce the concept by picturing the phenomenon and allow students to see how changing the input variables affect the outcome. Simulations can then be used to Extrapolate the concept to “cosmic size scale” objects or “atomic size scale” objects. This approach allows the understanding of one system to be applied to another, and consistently reinforces the basic concepts. The method embodies and implements current thinking on the teaching of science, and it uniquely combines tutorials, hands-on experiments and simulations, into the Four-E method with matching hands-on and simulation experiments.

Students experience the computer simulations by sight (visually absorbing what is displayed on the computer screen) and sound (heard from the computer's speakers) and by investigating changes in the simulation that occur in response to changes made by the student to the input parameters. Those parameters are adjusted using slide bars (as depicted in FIGS. 9 and 13) and buttons (as depicted in FIGS. 7, 9 and 13); other conventional means for adjustment and/or selection include the manipulation of a mouse, typing-in data, touching a screen, or clicking an indicator (as shown in FIG. 10 by the dots in the circles).

A further, unique alternative to the other data input methods described utilizes an external, remote input device to effectively connect the students' senses as a real-time input to a computer simulation. For example, in a basketball simulation (such as that of FIG. 4) or a projectile experiment (such as that of FIG. 5), a hand-held accelerometer could be employed to input the starting velocity of the basketball, or other projectile. The student would go through the motion of throwing the basketball, and the accelerometer feature of the sensor device 10′ would determine the maximum speed and direction of the throw or shot. Those parameters would be communicated by a wire, or wirelessly, to the computer (such as by using BLUETOOTH communication technology) and utilized as the input for the simulation.

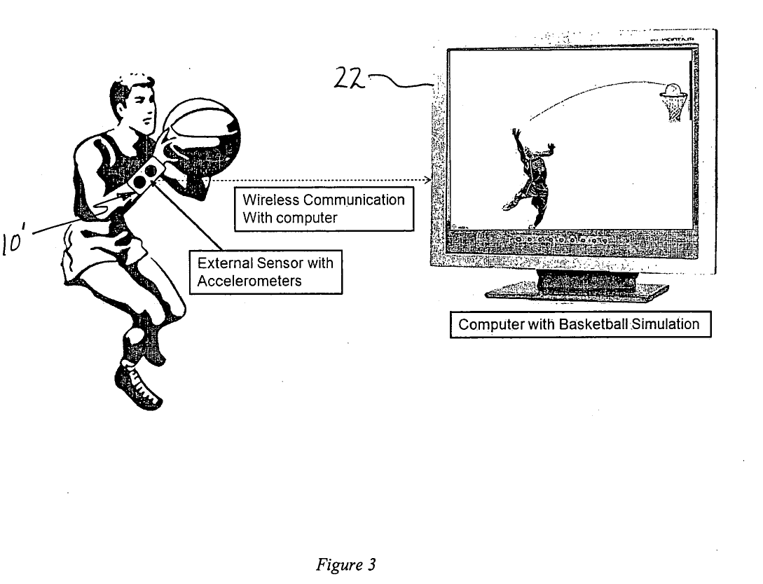

FIG. 3 illustrates the foregoing concept, and shows a student, wearing on his wrist a remote, wireless sensor device 10′ constructed to function as an accelerometer, going through the motions of shooting a basketball. The sensor data (starting velocity of the basketball, its maximum speed, and the direction of throw) are input to a local computer 22 by the wireless connection, indicated by the dotted line arrow, and applied so as to affect the computer simulation, as illustrated in FIG. 4; thus, the figure shows the trajectory of a ball thrown with the speed, and in the direction, produced by the student's motions. The strength of the gravitational field applied could be modified in the simulation to illustrate how that change would affect the ball trajectory achieved by the student with his simulated throw.

In a related exercise, the student could hold the remote sensor while jumping. The maximum velocity achieved would serve as input to show how high a jump he or she would make in earth's gravity, and could be checked against the actual result. Again, the gravitational force applied in the simulation could then be changed, and the new trajectory of the jump be determined. These examples demonstrate how a student can expand his experience of the simulation to his kinesthetic senses, as well as to his visual (and audial) senses.

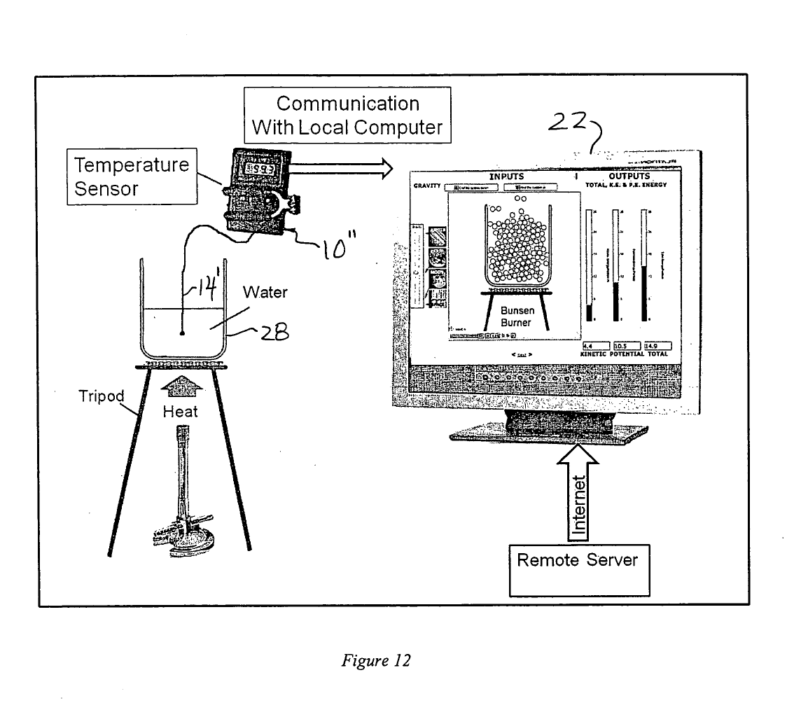

In another example, illustrated in FIG. 12, an experiment on phase change uses the temperature, measured using a detector device 10″, as an input to the simulation to explore the properties of the phase, at that temperature, on an “atomic-size scale.” In the experiment, the student observes the physical properties of the phases, as they change from ice to water to gas, during heating of the beaker 28. The simulation of the phase at the “atomic-size scale” in real time, at the same temperature as the experiment, allows the student to make a comprehensive description of each phase as a function of temperature. The simulation software can be installed on a local computer 22 or, as depicted in this figure, it can be downloaded over the Internet from a remote server. The simulation GUI for this coupled experiment and simulation is illustrated in FIG. 13.

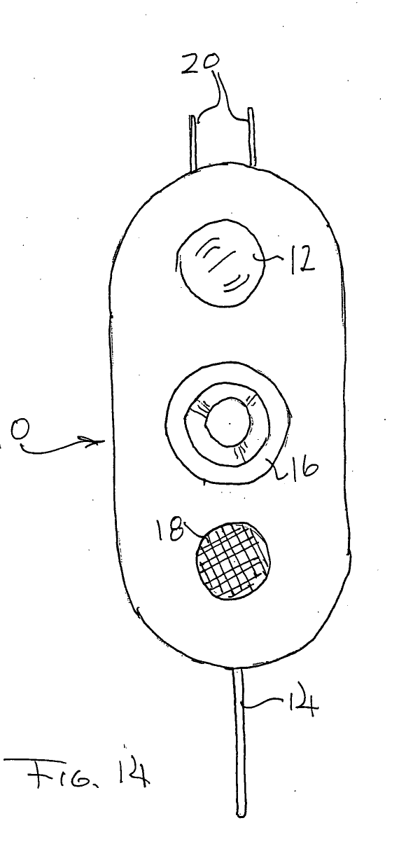

As indicated diagrammatically in FIG. 14, various kinds of detector devices, having a variety of different functions, could be employed for inputting physical data to the foregoing and other simulations. For example, sensors to detect acceleration, force, sound, light intensity, temperature, pressure, pH value, etc., can be provided.

More specifically, the sensor device depicted in FIG. 14, and generally designated by the numeral 10, has a button 12 for measuring the force exerted by thumb pressure, which effect could be employed in conjunction with accelerometers (internal to the sensor device) to determine the direction of the force. Such a sensor arrangement could be used to teach “Force and Motion” concepts, and the manual force exerted by the student could be used as input to a simulation which shows how a vehicle responds to the applied force; the applied external force substitutes for a force value that may be input using, for example, a computer display slide bar. The direction of the force can be changed by changing the direction of the hand-held remote sensor device.

A temperature sensor, such as thermocouple probe 14 incorporated into the device 10 (also shown as probe 14′ attached to the sensor 10″ in FIG. 12), could be used to generate an input to the simulation of atoms during the phase changes shown in FIGS. 8, 12 and 13. A microphone 16 could be used to detect sound, for exploring the effect of imposing atomic motion upon selected atoms in the several states (gaseous, liquid, and solid) shown in FIG. 8, and/or a motion sensor (responsive to jiggling or other movement) could be used in the same kind of experiment.

The sensor device 10 may also include a radiation detector 18, for measuring light intensity, coupled to a computer simulation in which the intensity of photons hitting the earth could be correlated to the intensity of light impinging on the sensor. The temperature sensor could also be coupled to the thermally emitted photon intensity coming from the earth. Finally, electrodes 20 on the device 10 might for example be employed for example in an experiment in which an experience, such as tasting, involves a chemical change, or ionization.

In a preferred embodiment, the “Science Units” are delivered through a web portal which can be accessed, with a proper password, on any computer, at school or at home. The home page of the web portal is designed as a lesson selection page. The page allows students to view and select any of the “Science Units” that are available for their grade. The available lessons for any grade can be accessed by passing the mouse over the grade identifier.

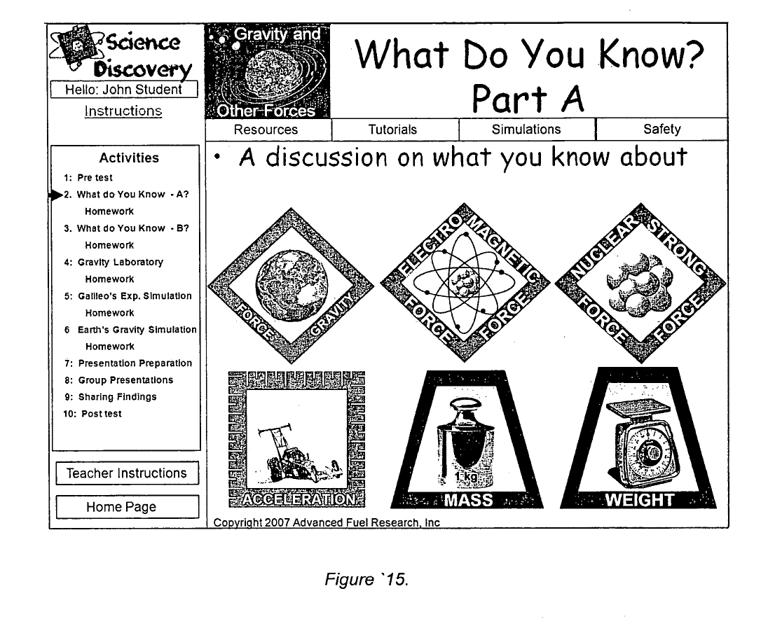

One example of a “Science Unit,” is (as previously discussed) entitled “Gravity and Other Forces.” All the pages for this unit would normally have the same layout, such as that of the computer-generated page illustrated in FIG. 15, with a menu bar of “Activities” (including homework) on the left and a subject title and menu bar of “Resources,” “Tutorials,” “Simulations” and “Safety” at the top. Each “Activity” typically represents a one-day lesson. There are links in the top menu and throughout the lessons to teacher instructions, handouts, worksheets, a concept organizer, vocabulary, tutorials, safety warnings, hands-on lesson instructions and simulations. The “Teacher Instruction” button at the lower left corner of the page provides a link to teacher instructions for the activity currently being displayed.

After a pretest, the activities start with a “What do You Know” activity, which is a teacher led-class discussion intended to Evoke what students know about the various aspects of Gravity and Other Forces. The goal of the discussion is to elicit the students' concepts (both correct and incorrect) of the topics in the lesson. The teacher keeps a list of the concepts on the blackboard, computer, or poster paper to check against what subsequent demonstrations, experiments and simulations exhibit. The discussion format involves: asking questions, discussing answers, discussing differences of opinion, and listing all concepts both correct and incorrect. The “What do You Know” resources include graphical user interface screens which pose the important questions. Each major concept or term has a visually meaningful icon, such as those shown in FIG. 15, to help students recognize the term and associate the word with the meaning.

A set of GUI screens is used to introduce and provide instruction for the hands-on activity called the “Gravity Laboratory.” This activity is matched by the “Galileo's Experiment Simulation.” The “Earth's Gravity Simulation” activity extrapolates the force of gravity concept to cosmic scales.

The “Presentation Preparation” and “Group Presentation” activities are designed to have students, working in research groups, present what they learned in the Science Unit or their answer to a particular challenge question. GUI screens introduce the requirements for these activities and are linked to “Teacher Instructions” using the button at the bottom of the left hand menu.

GUI screens from the “Sharing Findings” activity of the “Gravity and Other Forces” “Science Unit” provides answers to the questions posed in the “What do You Know” activity.

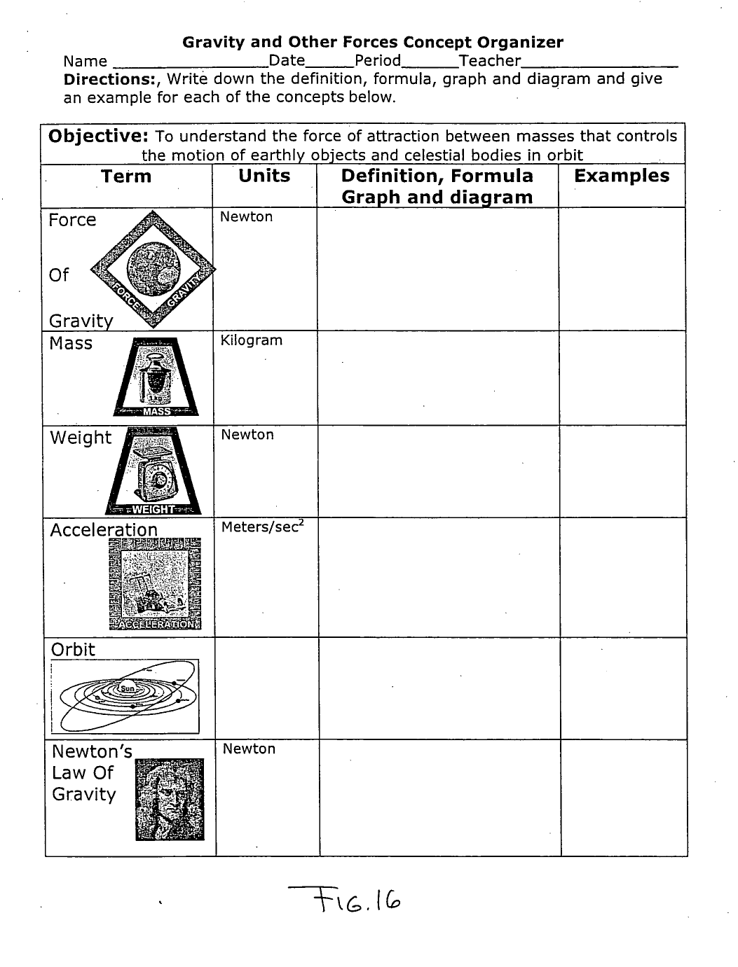

Other materials available on the web portal are accessed using the menu bar at the top of the screen in FIG. 15. A “Concept Organizer,” illustrated in FIG. 16, is available under the menu that drops down from the “Resources” button for each “Science Unit”. Using the “Concept Organizer” students complete the definitions and examples for the important concepts and terms used in each Science Unit. Each major concept or term has an associated, visually meaningful symbol, or icon, such as those illustrated in FIGS. 15 and 16 (some of which are common to both items) to help students recognize the term and associate the word with the meaning.

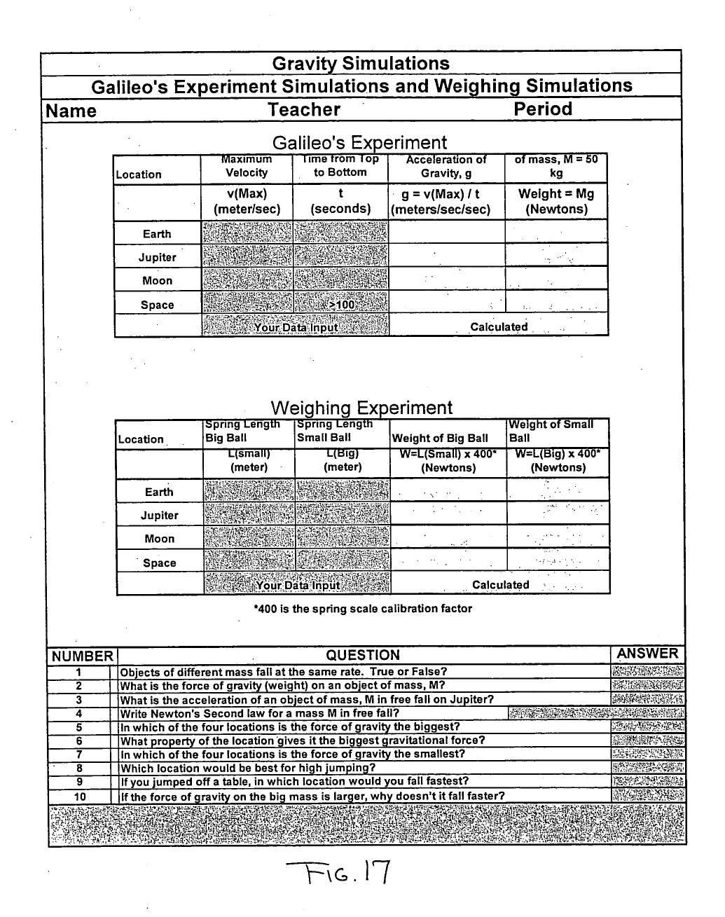

Worksheets for the hands-on experiments and simulations are also available under the “Resources” menu, as shown in FIG. 17. These worksheets may be supplied as tangible items, along with other components of the system, or they may be downloaded and printed. They would desirably bear icons to identify them to each of the several concepts for which the data processing means is programmed, as would the tangible experimentation devices provided.

The “Tutorials” button in FIG. 15 provides a menu of animated tutorials that are available on the web portal relevant to the “Science Unit” topic. Some tutorials use music and lyrics (especially rhyme) to help students remember the important science concepts.

Thus, it can be seen that the present invention provides a novel system and method by which modern computer capabilities can be harnessed in a manner that is highly effective for teaching science. Hands-on experiments and/or ambient phenomena are integrated into the system and method to afford significant pedagogical benefits; this is accomplished through the provision of computer simulations, coupled with the utilization of data obtained from matching experiments and/or detected from the ambient, as real-time inputs to a corresponding computer simulation.

The invention provides a system that includes electronic data processing means and at least one tangible experimentation device and/or at least one detector device. The electronic data processing means is programmed for dynamically simulating and displaying, on a local computer, an experiment that utilizes at least one variable parameter and that involves a scientific concept to which the variable parameter is pertinent. The tangible experimentation device is adapted for use in performing a hands-on experiment that utilizes the same variable parameter and is illustrative of the same scientific concept; the detector device is responsive to an ambient phenomenon that also involves the same parameter.

Having thus described the invention, what is claimed is:

1. A system for teaching scientific concepts, comprised of a plurality of components and including programmed electronic data processing means comprised of at least one local computer, said electronic data processing means being programmed for dynamically simulating and displaying on said at least one local computer an experiment that utilizes at least one variable parameter and that involves a scientific concept to which said at least one variable parameter is pertinent; at least one tangible experimentation device for use in performing a hands-on experiment that utilizes said at least one variable parameter and is illustrative of said scientific concept; and a detector device comprising at least one detector that is responsive to an ambient phenomenon involving said at least one variable parameter, said detector device being constructed for generating a signal that is representative of the detected phenomenon and being operatively connected to said local computer for inputting the representative signal thereinto for processing by said data processing means, said local computer being constructed for receipt of said representative signal for varying said at least one variable parameter of said simulated experiment.

2. The system of claim 1 wherein said electronic data processing means is programmed for receipt and processing of signals, generated by direct inputs to said local computer, for varying said at least one variable parameter of said simulated experiment, said local computer being constructed for receiving such direct inputs.

3. The system of claim 2 wherein said electronic data processing means is programmed and constructed for interactive receipt of such direct inputs.

4. The system of claim 1 wherein said electronic data processing means includes an Internet server, and wherein said local computer is programmed for operative connection to said Internet server.

5. The system of claim 4 wherein said Internet server is programmed for dynamically simulating said experiment.

6. The system of claim 1 additionally including tangible printed materials, said printed materials comprising a plurality of items and having correlating means thereon, at least one item of said printed materials corresponding to each of said plurality of scientific concepts and being correlated thereto by said correlating means.

7. The system of claim 6 wherein said correlating means comprising a plurality of different icons, one of said icons correlating said at least one item of said printed materials to said each scientific concept.

8. A system for teaching scientific concepts, comprised of a plurality of components and including programmed electronic data processing means comprised of at least one local computer, said electronic data processing means being programmed for dynamically simulating and displaying on said at least one local computer an experiment that utilizes at least one variable parameter and that involves a scientific concept to which said at least one variable parameter is pertinent; and at least one tangible experimentation device for use in performing a hands-on experiment that utilizes said at least one variable parameter and is illustrative of said scientific concept.

9. The system of claim 8 wherein said electronic data processing means is programmed for so simulating and displaying a plurality of experiments, at least one of said experiments involving each of a plurality of different scientific concepts, and wherein said system includes a plurality of said experimentation devices, at least one of said experimentation devices utilizing a said variable parameter that is illustrative of each of said plurality of scientific concepts.

10. The system of claim 8 wherein the functional features of said tangible experimentation device match the features of said simulated experiment in all significant respects.

11. The system of claim 8 wherein said simulated experiment illustrates said scientific concept on at least one scale that is selected from the group consisting of a human-size scale, an atomic-size scale, and a cosmic-size scale.

12. The system of claim 8 wherein said electronic data processing means is additionally programmed for presenting, on said local computer, by visual or audial means, or both, a supplemental educational tool related to said scientific concept and selected from the group consisting of a tutorial, student activities-evoking materials, experiment-extrapolating materials, a concept organizer, teacher instructions science-based vocabulary, lyrics, music, and combinations thereof.

13. The system of claim 12 wherein said supplemental educational tool has correlating means thereon correlating the subject matter thereof to said scientific concept.

14. The system of claim 8 additionally including tangible printed materials, said printed materials having correlating means thereon correlating the subject matter thereof to said scientific concept.

15. A system for teaching scientific concepts, comprised of a plurality of components and including programmed electronic data processing means comprised of at least one local computer, said electronic data processing means being programmed for dynamically simulating and displaying on said at least one local computer an experiment that utilizes at least one variable parameter and that involves a scientific concept to which said at least one variable parameter is pertinent; and a detector device comprising at least one detector that is responsive to an ambient phenomenon involving said at least one variable parameter, said detector device being constructed for generating a signal that is representative of the detected phenomenon and being operatively connected to said local computer for inputting the representative signal thereinto for processing by said data processing means, said local computer being constructed for receipt and processing of said representative signal for varying said at least one variable parameter of said simulated experiment.

16. The system of claim 15 wherein said ambient phenomenon to which said at least one detector is responsive is at least one of motion, velocity, acceleration, sound, light, force, pressure, weight, volume, distance, thermal conditions, magnetic fields, electric fields, odor, taste, and chemical properties.

17. The system of claim 16 wherein said at least one detector device is hand-held.

18. The system of claim 17 wherein said at least one detector is an accelerometer.

19. A method for teaching scientific concepts, utilizing programmed electronic data processing means comprised of at least one local computer, a tangible experimentation device, and a detector device, said electronic data processing means being programmed for dynamically simulating and displaying on said at least one local computer an experiment that utilizes at least one variable parameter and that involves a scientific concept to which said at least one variable parameter is pertinent, said tangible experimentation device being constructed for use in performing a hands-on experiment that utilizes said at least one variable parameter and is illustrative of said scientific concept, and said detector device comprising at least one detector that is responsive to an ambient phenomenon involving said at least one variable parameter, said detector device being constructed for generating a signal that is representative of the detected phenomenon and being operatively connected to said local computer for inputting the representative signal thereinto for processing by said data processing means, said local computer being constructed for receipt of said representative signal for varying said at least one variable parameter of said simulated experiment; wherein said method comprises the steps:
operating said electronic data processing means so as to dynamically simulate and display on said local computer a said experiment that utilizes at least one variable parameter and that involves a scientific concept to which said at least one variable parameter is pertinent;
performing, by use of said tangible experimentation device, a hands-on experiment that utilizes said at least one variable parameter and is illustrative of said scientific concept; and
subjecting said detector device to said ambient phenomenon involving said at least one variable parameter so as to input into said local computer a said representative signal generated by said at least one detector.
